(19) United States
(12) Patent Application Publication
(10) Pub. No.: US 2024/0019077 A1
(43) Pub. Date: Jan. 18, 2024

(54) POSITIONER STRUCTURE CAPABLE OF LABOR-SAVING INSTALLATION

(71) Applicant: OXTI Pte Ltd, Singapore (SG)

(72) Inventor: Chih-Feng Ho, Singapore (SG)

(21) Appl. No.: 17/867,658

(22) Filed: Jul. 18, 2022

(51) Int. Cl. F16M 13/02

(52) U.S. Cl. CPC F16M 13/02; F16M 13/027

(57) ABSTRACT

A positioner structure capable of labor-saving installation includes: a top seat, having a first surface and second surface opposite to each other, the first surface provided with a sticking part, and the second surface a fixing portion; and a bracket, having a first end and second end, the first end provided with a clipping groove adapted to clamp the fixing portion of the top seat, and the second end having a coupling portion. Therefore, the top seat is first stuck on a plane through the sticking part, and a screw driver is then used to lock the top seat 1 on the plane; the fixing portion of the top seat allows the clipping groove to be clamped on the top seat to make the bracket in combination with the top seat; the coupling portion can be in combination with the coupled portion, thereby realizing the positioning of the coupled portion.

### (a) TECHNICAL FIELD OF THE INVENTION

The present invention relates to a positioner structure capable of labor-saving installation, and more particularly to a positioner structure capable of labor-saving installation with a sticking part.

### (b) DESCRIPTION OF THE PRIOR ART

Taiwan Patent No. M607338, titled “power supply holder structure”, uses a fixing bracket and a fixing press sheet to clamp and fix the power line connecting base in a way of front and rear clipping to be integrated, and then locks it on the inner side of the housing. Further, Taiwan Patent No. M622396 discloses a fixing bracket adapted to assemble a camera, including a shell element, ball-typed shaft, rotary shaft and pressing element, thereby fixing the fixing bracket at the location where the camera will be placed, but during installation, a user's one hand must be first used for pressing and fixing, and another hand rotate screws, which makes the limbs easy to fatigue during installation. When it is to be fixed at a high place, ceiling, etc., where it is difficult to fix and rotate the screws at the same time, there is a risk of accidental drop and injury.

### SUMMARY OF THE INVENTION

To overcome the above disadvantages, the present invention proposes a positioner structure capable of labor-saving installation, including: a top seat, having a first surface and second surface opposite to each other, the first surface provided with a sticking part, and the second surface a fixing portion; and a bracket, having a first end and second end, the first end provided with a clipping groove adapted to clamp the fixing portion of the top seat, and the second end having a coupling portion,
wherein, the top seat is provided with a screw hole penetrating the first surface and second surface.
wherein, a groove is provided around the fixing portion.
wherein, the clipping groove is a U-typed structure.
wherein, the coupling portion is a T-typed structure.

With the above structure, the top seat is first stuck on a plane through the sticking part, and a screw driver is then used to lock the top seat 1 on the plane; the fixing portion of the top seat allows the clipping groove to be clamped on the top seat to make the bracket in combination with the top seat; the coupling portion can be in combination with the coupled portion, where the coupled portion may be an electronic device, Wi-Fi device or speaker, thereby realizing the positioning of the coupled portion. Therefore, the present invention can overcome the disadvantage of a user's one hand first pressing the top seat, and another hand then using a screw to lock the top seat during installation in the prior art, and achieve a labor-saving installation effect.

### BRIEF DESCRIPTION OF THE DRAWINGS

FIG. 1 is an exploded view of the present invention;

FIG. 2 is a perspective view of the present invention after assembly;

FIG. 3 is a perspective view of the present invention when a screw is being used to lock a top seat;

FIG. 4 is a perspective of the present invention before assembly;

FIG. 5 is a perspective view of the present invention before an electronic device is installed; and

FIG. 6 is a perspective view of the present invention after an electronic device is installed.

### DETAILED DESCRIPTION OF THE PREFERRED EMBODIMENTS

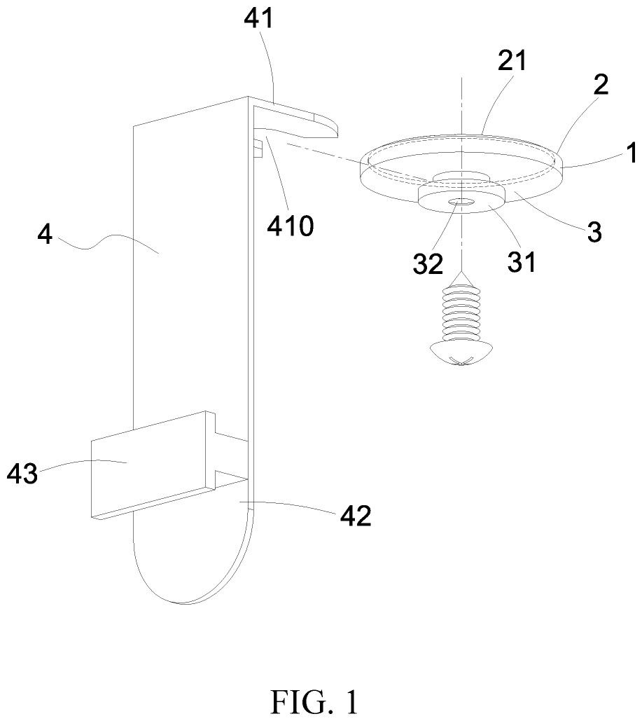

Referring to FIG. 1, a positioner structure capable of labor-saving installation of the present invention includes: a top seat 1, having a first surface 2 and second surface 3, where the first surface 2 is provided with a sticking part 21, and the second surface 3 a fixing portion 31; and a bracket 4, having a first end 41 and second end 42, where the first end 41 is provided with a clipping groove 410 adapted to clamp a fixing portion 31 of the top seat 1, and the second end 42 a coupling portion 43. Specifically, the sticking part 21 may be adhesive or double-sided tape.

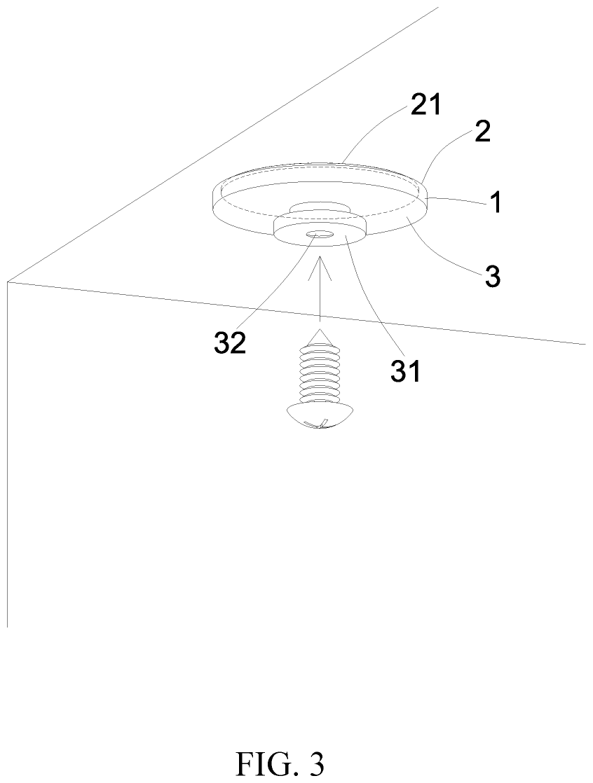

Referring to FIG. 3, the sticking part 21 may be stuck to a plane (e.g., ceiling) where the positioner structure wants to be fixed to. Furthermore, the top seat 1 is provided with a screw hole 32 penetrating the first surface 2 and the second surface 3, allowing a fixing element (e.g., screw) to be passed through the screw hole 32 to fix the fixing portion 31 more surely on the plane.

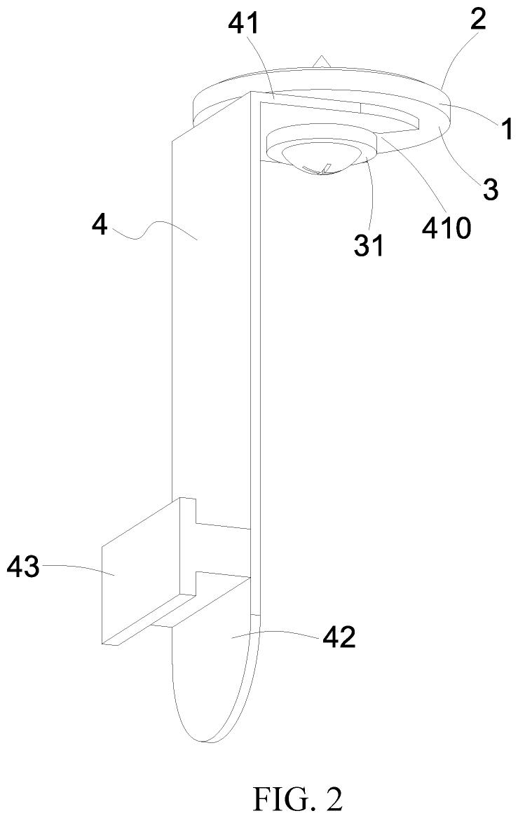

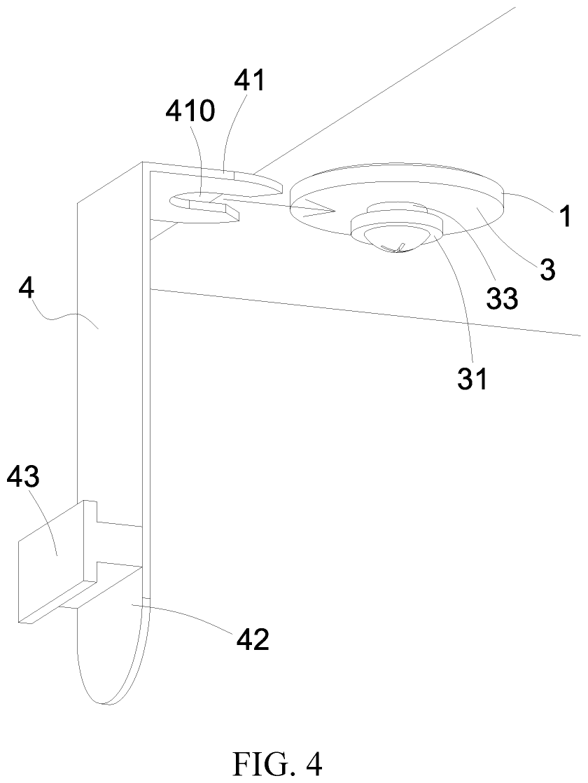

Referring to FIGS. 2 and 4, the fixing portion 31 of the top seat 1 is coupled to the first end 41 of the bracket 4 by means of gluing, sticking, locking or clamping to fix the bracket 4 to one side of the fixing portion 31. In the embodiment, a groove 33 is provided around the fixing portion 31. Furthermore, the first end 41 is provided with a U-typed structure of clipping groove 410, thereby allowing the bracket 4 to be stably engaged with the top seat 1 without dropping easily, thereby realizing the coupling of the top seat 1 to the bracket 4 by engaging the clipping groove 410 with the groove 33 provided around the fixing portion 31.

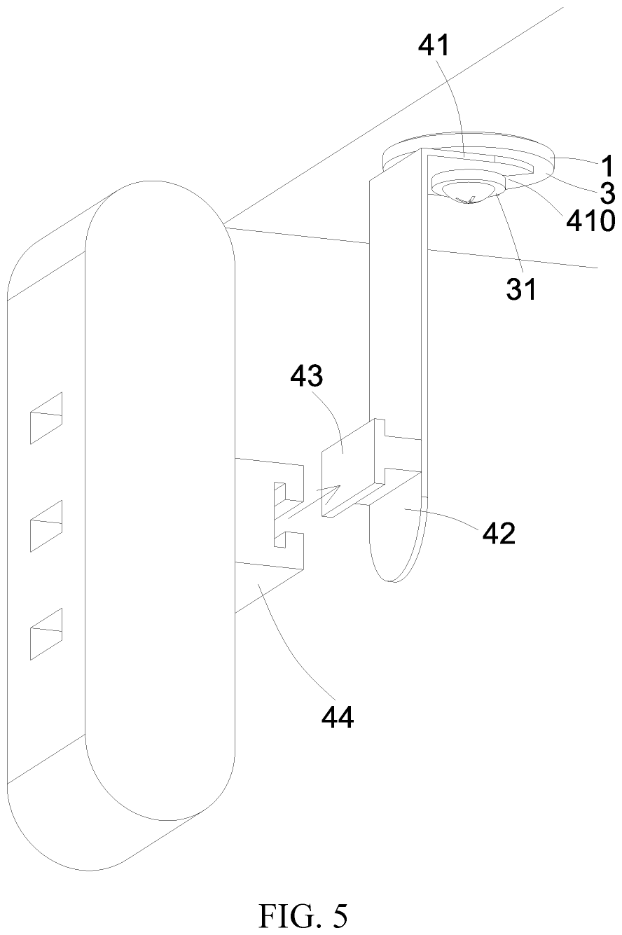

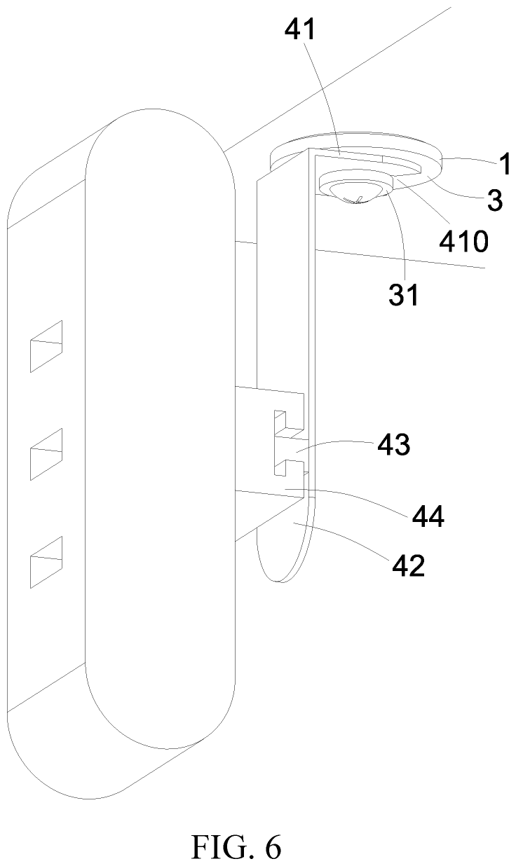

Referring to FIGS. 5 and 6, the coupling portion 43 can be in combination with a coupled portion 44, which may be an electronic device, Wi-Fi device or speaker, thereby realizing the positioning of the coupled portion 44. In the embodiment, the coupling portion 43 is a T-typed structure, and the coupled portion 44 a C-typed structure; the coupling portion 43 is engaged with the coupled portion 44, and the coupled portion 44 can then be fixed on the positioner structure of the present invention.

With the above structure, the top seat 1 is first stuck on a plane through the sticking part 21, and a screw driver is then used to lock the top seat 1 on the plane; the fixing portion 31 of the top seat 1 allows the clipping groove 410 to be clamped on the top seat 1 to make the bracket 4 in combination with the top seat 1; the coupling portion 43 can be in combination with the coupled portion 44, where the coupled portion 44 may be an electronic device, Wi-Fi device or speaker, thereby realizing the positioning of the coupled portion 44. Therefore, the present invention can overcome the disadvantage of a user's one hand first pressing the top seat, and another hand then using a screw to lock the top seat during installation in the prior art, and achieve a labor-saving installation effect.

I claim:

1. A positioner structure capable of labor-saving installation, comprising:
a top seat, having a first surface and second surface opposite to each other, said first surface provided with a sticking part, and said second surface a fixing portion; and
a bracket, having a first end and second end, said first end provided with a clipping groove adapted to clamp said fixing portion of said top seat, and said second end having a coupling portion.

2. The structure according to claim 1, wherein said top seat is provided with a screw hole penetrating said first surface and second surface.

3. The structure according to claim 1, wherein a groove is provided around said fixing portion.

4. The structure according to claim 1, wherein said clipping groove is a U-typed structure.

5. The structure according to claim 1, wherein said coupling portion is a T-typed structure.
